(19) United States
(12) Patent Application Publication
(10) Pub. No.: US 2018/0012266 A1
(43) Pub. Date: Jan. 11, 2018

(54) COMPUTER IMPLEMENTED METHODS AND SYSTEMS FOR COMPREHENSIVELY IDENTIFYING DECLINED SERVICES FROM SERVICE WRITE UP RECORDS

(71) Applicants: Kunal Joshi, Ann Arbor, MI (US); Keith Thompson, Ann Arbor, MI (US); Nandit Soparkar, Ann Arbor, MI (US)

(72) Inventors: Kunal Joshi, Ann Arbor, MI (US); Keith Thompson, Ann Arbor, MI (US); Nandit Soparkar, Ann Arbor, MI (US)

(21) Appl. No.: 15/714,371

(22) Filed: Sep. 25, 2017

Related U.S. Application Data
(60) Provisional application No. 62/468,659, filed on Mar. 8, 2017.
(60) Provisional application No. 62/465,284, filed on Mar. 1, 2017.

(51) Int. Cl. G06Q 30/02; G06F 17/27; G06F 19/00

(52) U.S. Cl. CPC G06Q 30/0276; G06F 17/2785; G06F 17/277; G06F 19/322

(57) ABSTRACT

Computer implemented methods and systems are disclosed for automatically identifying declined services from service records by extracting information from fields in the service record, analyzing the extracted information to identify issues found and issues addressed in the service record, comparing the issues found and issues addressed to identify issues found in the service record unrelated to the issues addressed, and inferring the issues found unrelated to the issues addressed to be declined services.

### CROSS REFERENCE TO RELATED APPLICATIONS

This application claims priority from U.S. Provisional Patent Application No. 62/468,659 filed on Mar. 8, 2017 entitled COMPUTER IMPLEMENTED METHODS AND SYSTEMS FOR COMPREHENSIVELY IDENTIFYING DECLINED SERVICES FROM SERVICE WRITE UP RECORDS and U.S. Provisional Patent Application No. 62/465,284 filed on Mar. 1, 2017 entitled FINDING DECLINED SERVICES FOR MARKETING FROM SERVICE WRITE UP, both of which are hereby incorporated herein by reference.

### BACKGROUND

The present application relates generally to computer-implemented methods and systems for analyzing service records to automatically identify declined services.

Ia: Servicing of products is a large revenue source for groups or individuals that provide the services. In order to obtain such revenue, services need to be marketed and offered to the intended audience (i.e., usually the product user, where we generally use the term “user” to include, among others, the owner, responsible party, or other safe-keeper for the product), and often the audience comprises end-consumers. Such offers for services are best received and responded to when they are timely, relevant, and specific to the recipient.

Ib: A particular type of offer, called a “declined service offer,” may be described as follows. When a specific product is being serviced at a service location, the service provider may notice some additional aspects of service deemed to be important or necessary. The service provider may suggest to the product user that the additional aspects also be serviced during that same service session. However, for various reasons, such as cost, time availability, or perhaps disbelieving the importance or necessity of the additional service aspects, the product user may decide not to have the suggested services performed in that session. For such situations with declined services, it is well-known that successful response rates are high when timely declined service offers are made to the product user.

Ic: Often the above-described declined service marketing efforts are limited in their efficacy. This limitation usually comes about because it is not easy to identify what services were declined for a particular service session instance. Either the service provider personnel must specifically mark (e.g., assign a particular code) a service record (which memorializes the associated service session details), or the declined services need to be determined in some way from the contents of a service record. Service provider personnel are often reticent to admit or otherwise state that an additional suggested service was declined, since that may reflect poorly on their business communication abilities. In addition, the service write up may simply be written up inadequately or poorly, which could make it very difficult to identify the declined services.

Id: Current approaches to identify declined services are generally limited to examining only those service records in detail that have specific wording or codes that explicitly indicate declined services, and these approaches usually identify a relatively small subset of the potential declined services cases. However, a much larger and comprehensive set of potentially declined services may be identified by examining all service records in detail: the service write up (which is usually part of each service record), together with information from each service record on the services actually performed, provides information on the potential declined services associated with that service record.

Ie: A service write up may directly state that certain suggested services were “declined” by the product user. Or, similarly, a write up may use wording (e.g., such as “recommended”) that is indicative of services suggested to the product user (but which were not necessarily done). In both these simple cases, the service write up provides information on the declined services with sufficient clarity. If the service records provide simple means to check for services actually done, then such direct wording in the write up may be used to identify declined services easily.

If: Now, as explained above in paragraph Ic, the service write up wording may not state declined services clearly, nor may appropriate declined service codes be assigned. Even so, each service record write up usually does include information on the issues found in the product (i.e., often due to which the declined services were offered), and various potential services (whether or not performed), in order to provide a record to the product user. Each such write up potentially has sufficient information to infer some declined services, if any, as described below in further detail. As discussed in further detail below, methods and systems in accordance with various embodiments use information extracted from each service write up to determine issues found in the product, compare these issues with the actual services performed, and use the difference between the two to infer the potential declined services.

### BRIEF SUMMARY OF THE DISCLOSURE

A computer implemented method in accordance with one or more embodiments is disclosed for automatically identifying declined services from service records. The method includes the steps, performed by a computer system, of: (a) receiving a service record at the computer system; (b) extracting information from fields in the service record; (c) analyzing the information extracted in (b) to identify one or more issues found and one or more issues addressed; (d) comparing the one or more issues found and one or more issues addressed identified in (c) to identify one or more issues found in the service record unrelated to the one or more issues addressed, and inferring the one or more issues found unrelated to the one or more issues addressed to be one or more declined services; and (e) outputting information on the one or more declined services.

A computer system in accordance with one or more embodiments includes at least one processor, memory associated with the at least one processor, computer input and output devices, and a program supported in the memory for automatically identifying declined services from service records. The program contains a plurality of instructions, which, when executed by the at least one processor, cause the at least one processor to: (a) receive a service record; (b) extract information from fields in the service record; (c) analyze the information extracted in (b) to identify one or more issues found and one or more issues addressed; (d) compare the one or more issues found and one or more issues addressed identified in (c) to identify one or more issues found in the service record unrelated to the one or more issues addressed, and infer the one or more issues found unrelated to the one or more issues addressed to be one or more declined services; and (e) output information on the one or more declined services.

### BRIEF DESCRIPTION OF THE DRAWINGS

FIG. 1 depicts an example of identifying declined services via direct wording in a service record, in order to send service offers.

FIG. 2 depicts an example of inferring declined services indirectly via a comparison process (between a service record write up and the performed services), in order to send offers in accordance with one or more embodiments.

FIGS. 3 and 4 are flowcharts illustrating exemplary processes for identifying declined services in service records in accordance with one or more embodiments.

FIG. 5 is a simplified block diagram illustrating an exemplary computer system in which various processes described herein may be implemented.

### DETAILED DESCRIPTION

Various embodiments disclosed herein relate to computer-implemented methods and systems for analyzing service records to automatically identify declined services. A service record is an electronic record that memorializes details of a service session. Examples of service records include, but are not limited to, product service records (e.g., automotive repair or service records) and medical records. While some examples described herein refer to automotive repair or service records, it should be understood that embodiments disclosed herein are not limited to such records and can also apply to a variety of other service records.

IIa: In accordance with one or more embodiments, computer-implemented methods and systems are disclosed for comparing information extracted from text (or other) fields in electronically recorded service records that describe (a) the actual services performed (e.g., “labor opcode” description in an automotive service record) and (b) activity or information associated with the service session as recorded by the service provider personnel (e.g., the service advisor or technician “story”) (the “Comparison”). The Comparison, in accordance with one or more embodiments, increases the number of potential declined services identified, and thereby, helps to address the shortcomings identified in paragraph Ic above.

IIb: We provide an illustrative example of the Comparison using automotive service visits. Consider a service visit for which a service record (i.e., sometimes called a repair order) is created. Some relevant narrative text fields in such a record may include concern, cause, and correction fields, not all of which may be filled out (e.g., neither concern nor cause fields may be populated for a maintenance service). Non-narrative text fields may include labor opcode descriptions for each service activity actually performed during the service visit.

IIc: Both, the narrative and the non-narrative text fields, do not have standard wording across service locations. Continuing our automotive service example, note that narrative text field contents widely differ across different records, even for the same types of service being described. These differences arise since different individuals describe the same ideas in different ways, and also, the same person may describe an idea differently across different records.

IId: Further continuing our automotive service embodiment example (in a manner somewhat similar to variations across all records in the narrative text fields, but with less variation across records from a specific service location), the labor opcode descriptions differ across different service locations. In fact, labor opcodes may not be directly comparable from one service location to another (e.g., one may have oil and filter change as a labor opcode, whereas another may have separate labor opcodes for oil service and filter clean/replace).

IIe: From the text fields described in the above paragraphs, information is extracted and organized into a common system (e.g., as described in U.S. patent application Ser. No. 15/679,712 entitled “COMPUTER-IMPLEMENTED METHODS AND SYSTEMS FOR CATEGORIZATION AND ANALYSIS OF DOCUMENTS AND RECORDS,” which is incorporated herein by reference) help realize the Comparison. One basic approach is to convert the information extracted from records (i.e., service records in our case) into a common lexicon and taxonomy, which facilitates the Comparison by reducing the variations (e.g., in text field wordings, as detailed in paragraphs IIc and IId above) across the service records. Any such common system may be used, and due to variations across the text fields (i.e., both narrative and non-narrative), our approach may use any appropriate and available means for natural language processing (NLP). By extracting the information from the text fields into a common system (e.g., using NLP), it becomes easier to do the Comparison. As an example, consider the following text write up in a service record: “Customer states window does not go up. Replaced window regulator. Checked Tire Press.” In accordance with one or more embodiments, the preceding write up may be converted by suitable NLP into set of “object-descriptor” pairs. Each such pair could consist of a vehicle component and a descriptor associated with that component. The set of components and descriptors would be defined in a common taxonomy. For this example, the object-descriptor pairs extracted may be (Window, Not Going Up), (Window Regulator, Replace), and (Tire Pressure, Check). In another example, if the service record comprises a medical record, each object-descriptor pair may comprise a body part or body system and a descriptor associated with that body part or body system defined in a common taxonomy.

IIf: Using the information extracted into a common system, the Comparison is done between the services actually performed and the services and issues in the narrative service write up. The services or issues from the write up that are largely unrelated to actual performed services are identified as being associated with potential declined services. With the automotive service example, those services and issues (e.g., as extracted from concern, cause, correction fields or any other text field) are identified to be potentially associated with declined services that are largely unrelated to the services performed (e.g., as may be extracted from the service write up, the labor opcode descriptions, or even from the parts involved with the service as usually available in a parts section of the service record) in the same service record. Services that address an issue are regarded as the services associated with or related to that issue (e.g., battery replacement is a service that addresses and is associated with a weak battery). Other services are regarded as unrelated to the services performed. For example, the set of related repairs for any given issue may be available in a “service-manual” for the product in question, which is service documentation often written up by an expert. In such product service-manuals, to further exemplify, for an issue such as “Weak Battery,” the repairs “Replace Battery” or “Charge Battery” may be shown as related repairs, whereas “Tire Pressure, Reset” would be considered unrelated.

Using both aspects of information, the service write up and the services performed, as usually available in a service record created for a service visit, the declined services may be extracted relatively reliably by software means.

### EXAMPLE 1

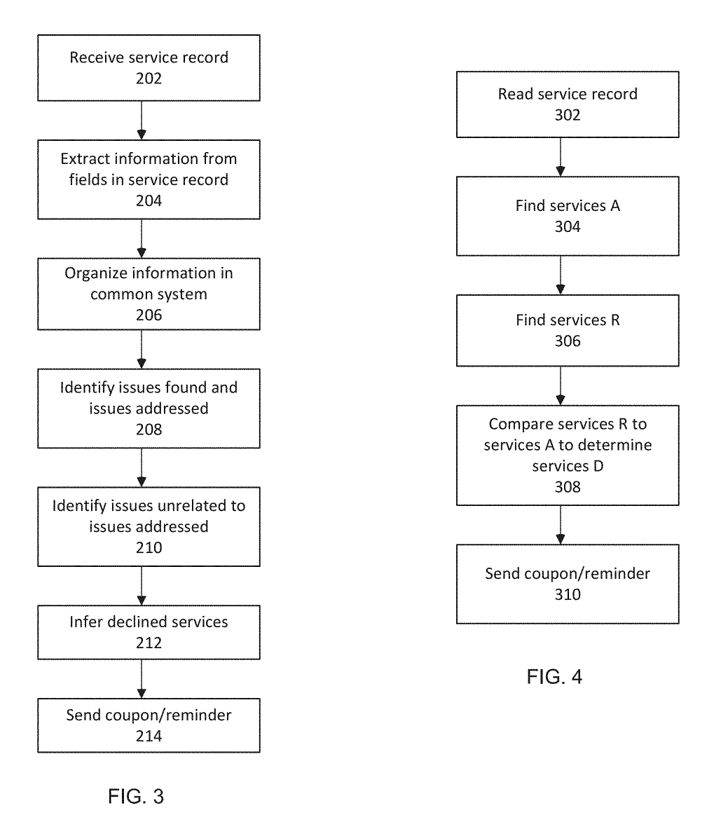

An exemplary process in accordance with one or more embodiments for identifying declined services from service write up records performed by a computer system is depicted in the flow chart of FIG. 3.

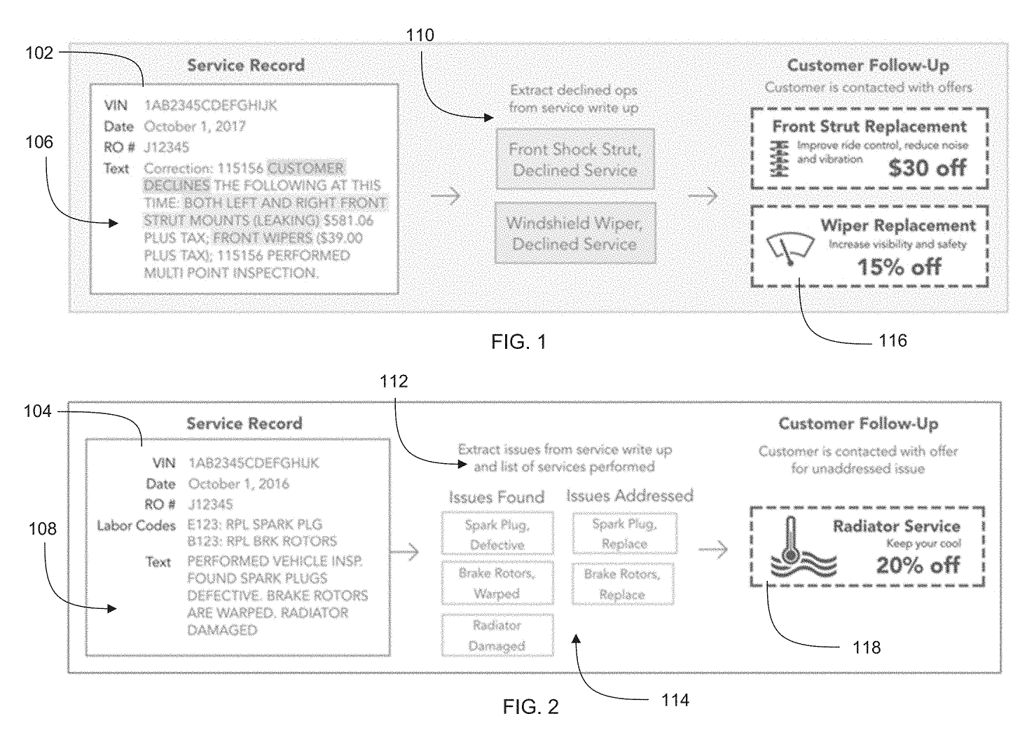

The computer system electronically receives a service record write up at step 202 for a particular customer. FIGS. 1 and 2 show simplified examples of such service records 102, 104.

The computer system extracts information from text fields 106, 108 in the service record, e.g., narrative fields and opcode fields at step 204. FIGS. 1 and 2 show simplified examples of such information 110, 112 extracted from the corresponding service records 104, 106.

The computer system organizes the extracted information in a common system, e.g., a common lexicon and taxonomy, at step 206. A simplified example of organizing the extracted information placed in (a portion of) a taxonomy is depicted at 114 in FIG. 2, where the items for issues found and issues addressed from the service record are placed under their taxonomy headings (i.e., of “Issues Found” and “Issues Addressed”, respectively).

The computer system analyzes the extracted information to identify all issues noted in the record (indicated by “Issues Found” in FIG. 2) at step 208. The computer system also identifies the services actually performed (identified by “Issues Addressed” in FIG. 2), which can also be based, e.g., on labor codes in the service record 104.

The computer system compares the services or issues noted in the record and the services actually performed to identify any services or issues that are unrelated to the services actually performed at step 210 (e.g., “Radiator Damaged” in FIG. 2).

The computer system infers these unrelated services or issues to be declined services, and outputs this information at step 212.

A reminder and/or offer 116, 118 can then be sent to the customer for the inferred declined services at step 214 (e.g., the radiator service coupon in FIG. 2).

### EXAMPLE 2

Information available in a service record is used to compare the service work actually performed (services A) with the service recommended or indicated as being needed (services R) during the service visit. The services R-A (i.e., services in R, but not in A) are inferred to be declined services (services D).

To do the comparison, consider the information as typically available in a service record:
i. The services A are usually indicated quite clearly (e.g., in the form of codes, exemplified by labor op codes in vehicle service, or medical procedure codes in healthcare patient visits). One reason why the services A are usually carefully noted is that payment, whether by the service recipient or insurance etc., is based on recording such services A (i.e., the service providers are usually careful to ensure that they will get paid for the services performed).
ii. For several reasons as described above, the services R may not be carefully noted. However, the services R may be determined from the contents of the service record. Such services R may be (a) explicitly indicated by special declined service codes in the record, (b) explicitly indicated as having been recommended, or suggested but declined, by specific wording in the record, or (c) implicitly indicated by certain codes (e.g., defect codes in the context of vehicle service, or diagnosis codes in healthcare patient visits) or wording in the record (i.e., that reflects there having been a recommendation or need for such services R). Note that it is irrelevant whether or not the wording in the service record has misspellings or grammar errors etc. (i.e., since we are interested in the content of recorded information, and we are not focused on the cleanliness or sloppiness of that information).

FIG. 4 illustrates an exemplary method performed by a computer system to identify the services D as follows:
1. At step 302, the computer system reads the contents of a given service record.
2. At step 304, the computer system finds the services A (e.g., by finding the codes pertaining to the services performed, and looking up a database of all service codes with which to compare).
3. At step 306, the computer system finds the services R as follows—
   a. For the case ii(a) above, find the codes for services performed in a database of all service codes.
   b. For the case ii(b) above, assign codes for services performed from a database of all service codes (e.g., by applying any available suitable NLP on the wording).
   c. For the case ii(c) above, first ascertain pertinent codes (i.e., that do not directly represent the services, but instead, are related to the services). Such codes may be already available in the record, or else are found as follows. Our method will assign pertinent codes (for services) from a database of all codes pertinent to services (e.g., by applying available suitable NLP on the wording in the record). After determining the pertinent codes, second ascertain the services related to the pertinent codes found from a database containing a mapping of all (pertinent) codes to the codes for related service. To exemplify, a pertinent code for vehicle services may be “Low voltage,” with the related service codes being “Replace Battery” or “Repair Alternator.” In this example, perhaps only pertinent defect codes may be ascertained from the record, and the related services may not be stated explicitly, but are derived indirectly by way of finding the pertinent codes.
   d. Note that the cases ii(a)-(c) above may be performed in combination (i.e., there may be a combination of explicitly and implicitly stated information present in a single service record, and any or all the described approaches may be used).

At step 308, services R are compared to services A. The services R-A (i.e., services in R, but not in A) are inferred to be declined services D.

At step 310, an offer or reminder can be sent to a user relating to the declined services.

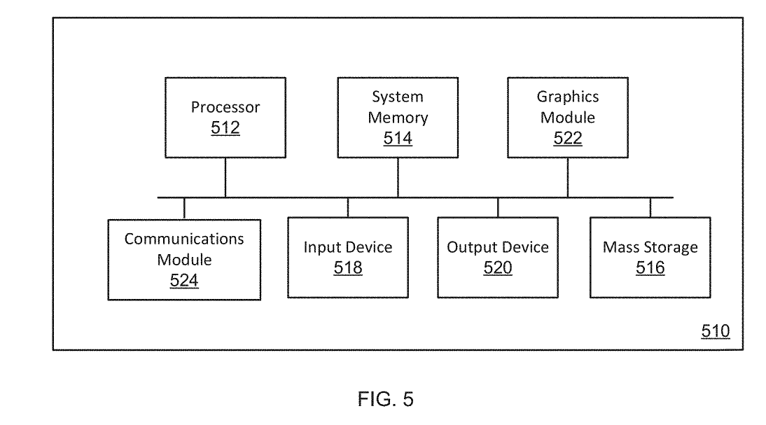

The methods, operations, modules, and systems described herein may be implemented in one or more computer programs executing on a programmable computer system. FIG. 5 is a simplified block diagram illustrating an exemplary computer system 510, on which the one or more computer programs may operate as a set of computer instructions. The computer system 510 includes, among other things, at least one computer processor 512, system memory 514 (including a random access memory and a read-only memory) readable by the processor 512. The computer system 510 also includes a mass storage device 516 (e.g., a hard disk drive, a solid-state storage device, an optical disk device, etc.). The computer processor 512 is capable of processing instructions stored in the system memory or mass storage device. The computer system additionally includes input/output devices 518, 520 (e.g., a display, keyboard, pointer device, etc.), a graphics module 522 for generating graphical objects, and a communication module or network interface 524, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

1. A computer implemented method of automatically identifying declined services from service records, comprising the steps, performed by a computer system, of:
(a) receiving a service record at the computer system;
(b) extracting information from fields in the service record;
(c) analyzing the information extracted in (b) to identify one or more issues found and one or more issues addressed;
(d) comparing the one or more issues found and one or more issues addressed identified in (c) to identify one or more issues found in the service record unrelated to the one or more issues addressed, and inferring the one or more issues found unrelated to the one or more issues addressed to be one or more declined services; and
(e) outputting information on the one or more declined services.

2. The method of claim 1, wherein at least some of the fields are text fields.

3. The method of claim 2, further comprising organizing the information extracted from the text fields in step (b) into a common system using natural language processing.

4. The method of claim 2, further comprising organizing the information extracted from the text fields in step (b) into a common lexicon and taxonomy using natural language processing.

5. The method of claim 2, further comprising using natural language processing to transform the information extracted from the text fields in step (b) into one or more object-descriptor pairs, wherein each object-descriptor pair comprises an object and a descriptor defined in a common taxonomy.

6. The method of claim 5, wherein the service record comprises a product service record, and each object-descriptor pair comprises a product component and a descriptor associated with that product component defined in a common taxonomy.

7. The method of claim 5, wherein the service record comprises a medical record, and each object-descriptor pair comprises a body part or body system and a descriptor associated with that body part or body system defined in a common taxonomy.

8. The method of claim 1, wherein step (c) comprises identifying the one or more issues addressed using (i) a labor opcode and/or parts identified in the service record when the service record comprises a product service record or (ii) a procedure or therapeutic action identified in the service record when the service record comprises a medical record.

9. The method of claim 1, wherein identifying the one or more issues found in step (c) comprises using natural language processing to analyze the extracted information to assign one or more pertinent codes from a stored list of a plurality of codes related to the extracted information, and determining services corresponding to the one or more pertinent codes from a database containing a mapping of a plurality of codes to services.

10. The method of claim 1, further comprising sending a reminder or offer relating the one or more declined services to a user associated with the service record.

11. The method of claim 1, wherein the service records comprise product service records or medical records.

12. A computer system, comprising:
at least one processor;
memory associated with the at least one processor;
computer input and output devices; and
a program supported in the memory for automatically identifying declined services from service records, the program containing a plurality of instructions which, when executed by the at least one processor, cause the at least one processor to:
(a) receive a service record;
(b) extract information from fields in the service record;
(c) analyze the information extracted in (b) to identify one or more issues found and one or more issues addressed;
(d) compare the one or more issues found and one or more issues addressed identified in (c) to identify one or more issues found in the service record unrelated to the one or more issues addressed, and infer the one or more issues found unrelated to the one or more issues addressed to be one or more declined services; and
(e) output information on the one or more declined services.

13. The computer system of claim 12, wherein at least some of the fields are text fields.

14. The computer system of claim 13, wherein the program further comprises instructions for organizing the information extracted from the text fields in (b) into a common system using natural language processing.

15. The computer system of claim 13, wherein the program further comprises instructions for organizing the information extracted from the text fields in step (b) into a common lexicon and taxonomy using natural language processing.

16. The computer system of claim 13, wherein the program further comprises instructions using natural language processing to transform the information extracted from the text fields in (b) into one or more object-descriptor pairs, wherein each object-descriptor pair comprises an object and a descriptor defined in a common taxonomy.

17. The computer system of claim 16, wherein the service record comprises a product service record, and each object-descriptor pair comprises a product component and a descriptor associated with that product component defined in a common taxonomy.

18. The computer system of claim 16, wherein the service record comprises a medical record, and each object-descriptor pair comprises a body part or body system and a descriptor associated with that body part or body system defined in a common taxonomy.

19. The computer system of claim 12, wherein the program comprises instructions for identifying the one or more issues addressed using (i) a labor opcode and/or parts identified in the service record when the service record comprises a product service record or (ii) a procedure or therapeutic action identified in the service record when the service record comprises a medical record.

20. The computer system of claim 12, wherein identifying the one or more issues found in (c) comprises using natural language processing to analyze the extracted information to assign one or more pertinent codes from a stored list of a plurality of codes related to the extracted information, and determining services corresponding to the one or more pertinent codes from a database containing a mapping of a plurality of codes to services.

21. The computer system of claim 12, wherein the program further comprises instructions for sending a reminder or offer relating the one or more declined services to a user associated with the service record.

22. The computer system of claim 12, wherein the service records comprise product service records or medical records.
